(19) United States
(12) Patent Application Publication
(10) Pub. No.: US 2006/0284553 A1
(43) Pub. Date: Dec. 21, 2006

(54) APPLYING A DISCONTINUOUS THIN LAYER ON A SUBSTRATE

(75) Inventors: Christophe G. Levarlet, Villeurbanne (FR); Jean-Marie Baumlin, Chalon-Sur-Saone (FR); Eric L. Fallet, Varennes Le Grand (FR)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/424,039

(22) Filed: Jun. 14, 2006

(30) Foreign Application Priority Data
Jun. 16, 2005 (FR) 0506091

(51) Int. Cl. H01J 1/62

(52) U.S. Cl. 313/506

(57) ABSTRACT

A rigid or flexible substrate (1) is comprised of one or several successive thin material layers (2, 9). The first thin material layer (9) is coated onto the substrate (1) and the other layers (2) are applied successively onto the first layer (9). Each thin layer has discontinuous prominent parts arranged in relief on the substrate (1). The thin layer (2, 9) can be electricity conducting. The finished product may be used for display screens or electronic circuits.

### CROSS REFERENCE TO RELATED APPLICATION

This is an application claiming priority to French Application Serial No. 0506091, Filed Jun. 16, 2005.

### FIELD OF THE INVENTION

The invention is in the technological field of thin layer materials applied to substrates, and intended especially to be used as display screens. The invention more specifically relates to a process for forming, by pressure and embossing, a discontinuous thin layer forming prominences on the substrate.

### BACKGROUND OF THE INVENTION

The means to manufacture thin devices, for example semiconductors or transistors, are known in the state of the art.

U.S. Patent Application Publication No. 2004/0002216 describes a method and system for forming a semiconductor device intended for microelectronics. The semiconductor device is formed from a substrate, preferably flexible, onto which is deposited at least one thin layer of resin. The assembly forms a continuous layer on the substrate. A stamping tool forms, in the resin, a three dimensional structure in a single block, i.e., the continuous layer has different heights and is formed as a single component. Then, parts of the thin layer are removed by an anisotropic engraving method, thus making the assembly of layers discontinuous on the substrate. During implementation of the method described, the continuous layer to discontinuous layer transition is performed by removing material. The successive steps in production of the semiconductor device enable the required degree of geometrical accuracy to be met. To produce discontinuous layer forms, the method described in U.S. Patent Application Publication No. 2004/0002216 takes place with the successive operations of layer deposition, stamping, and material removal, which has the disadvantage of not optimizing use of the material. Consequently, this method generates waste and generates production costs inherent to this waste and to the succession of operations.

U.S. Patent Application Publication No. 2004/0075155 discloses a method of fabricating a transistor device. The method discloses depositing at least one layer of electrically-conducting material to be deposited on a substrate, and then, using a previously heated presser device, pressure is applied to the deposited layer to insert, by stamping, part of the layer taking the pressure into the substrate, by simultaneously deforming the latter. The object of this method is to reduce the cost of fabricating transistors.

U.S. Pat. No. 5,234,717 discloses a process for rapidly engraving thin materials, and preferably optical disks. The forming of patterns, for example annular ones for optical disks, is carried out on the surface of the material coated on the disk substrate. These patterns, with size less than a micrometer (in width and depth) are produced superficially, on the coated surface, without crossing it.

### SUMMARY OF THE INVENTION

An object of the invention is a process to apply one or more thin material layers to a substrate. Each layer has discontinuous prominent parts arranged in relief on the substrate. It is an object of the method not to have the disadvantages and difficulties or constraints of controlling the operands linked to the methods of the prior art.

The invention has the advantage of being able to produce discontinuous layers with a wide range of thicknesses that can go from some tenth of micrometers to some hundreds of micrometers.

More specifically, the object of the invention is a process for forming, based on a continuous thin material layer deposited on a substrate, a layer discontinuous in at least two parts on the substrate, according to the following steps:
a) applying the continuous layer onto the substrate, the continuous layer being applied to the substrate in liquid phase or, alternatively, in gel phase;
b) gelling, if necessary, the continuous thin layer applied to the substrate;
c) having penetrate, through the whole thickness of the continuous thin layer held in gel state, at least one prominent element of an embossing device, the prominent element penetrating into the continuous layer under the effect of pressure by pushing the same quantity of material forming the thin layer into each of the formed parts of the discontinuous layer; and
d) removing the prominent element from the discontinuous layer formed.

The continuous layer that is applied to the substrate can itself be comprised of a plurality of separate layers.

In one embodiment, the invention described above, also comprises a step of solidification of the formed discontinuous layer. This solidification is performed after the step of removing the prominent element from the discontinuous layer.

According to another embodiment of the invention process, the prominent element of the embossing device is removed from the discontinuous layer after the solidification step of the formed discontinuous layer.

The prominent element of the embossing device penetrates into the continuous layer, or is removed from the formed discontinuous layer, in a direction perpendicular to the substrate surface. However, it is necessary that the prominent element does not contact the top surface external to and opposite the substrate of the discontinuous layer. The prominent element consists of a metal material, for example steel, and it penetrates into the continuous layer under the effect of pressure applied to said layer preferably between 1 MPa and 1000 MPa, so as to form the discontinuous layer.

In a particular embodiment, the prominent element penetrates into the continuous layer, or is removed from the formed discontinuous layer, with a rotary movement around an axis parallel to said layer.

The object of the invention is a process in which at least two thin material layers are applied to the substrate, and in which all the stages of the process described above are applied successively to each of said layers.

The embossing device of the invention advantageously includes a plurality of prominent elements each consisting of a metal material.

The object of the invention is also a substrate on which are deposited one or several thin material layers each having a pattern formed of at least two prominent elements made in the whole thickness of the thin material layer, the prominence being obtained with the invention process described above. The substrate is a rigid material constituted for example by metal, glass, or silicon. The substrate can also be a flexible material constituted for example of polyester, paper, or cellulose acetate. The thin material layer advantageously consists of a mixture containing gelatin and water. The formed prominent elements are for example square or rectangular forms, according to a cross-section in a plane parallel to the substrate. The thin material layer can be electricity conducting, and the substrate is thus advantageously used as an electronic display screen, radio frequency antenna (uses radio frequencies), or support for electric circuit having electronic functions by means of the thin material layer.

Other characteristics and advantages of the invention will appear on reading the following description, with reference to the various figures.

### BRIEF DESCRIPTION OF THE DRAWINGS

FIG. 1 shows a cross sectional view of a continuous thin material layer deposited on a substrate.

FIG. 2 schematically shows a cross sectional view of a first embodiment of the invention applied to a substrate on which a thin material layer is deposited.

FIG. 3 shows a cross-section of a substrate and a discontinuous layer produced according to the invention.

FIG. 4 schematically shows a cross sectional view of a second embodiment of the invention applied to a substrate on which two thin material layers are deposited.

FIG. 5 is a schematic view of the pattern shape made in a thin material layer.

FIG. 6 shows a schematic of a third embodiment of the invention applied to a substrate on which a thin material layer is deposited.

### DETAILED DESCRIPTION OF THE INVENTION

The following description is a detailed description of the main embodiments of the invention, with reference to the drawings, in which the same references identify the same elements in each of the different figures.

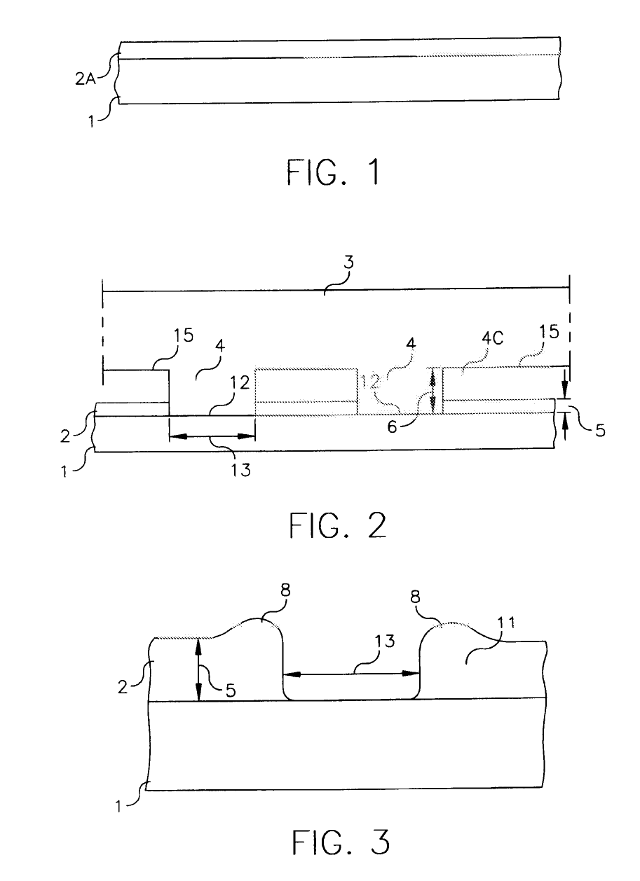

FIG. 1 represents a continuous thin material layer 2A deposited on a substrate 1. The substrate 1 is a support for the continuous layer, and it can be rigid or flexible. The substrate 1 is preferably flexible, and comprised of a material for example like a polyester. But the substrate 1 can also be a rigid support, for example in metal, glass, or silicon. The continuous layer 2A is a thin layer, i.e., its thickness is for example between some tenths of micrometers and some hundreds of micrometers. The layer 2A, for example, consists of a mixture containing gelatin and water. The layer 2A can be conductive of the electricity, for example by containing a conductive polymer, or metal particles. The layer 2A can also have special optical characteristics, for example by containing a dye or particles that diffuse light.

According to the invention process, and according to a first step, the continuous layer 2A is applied to the substrate 1 uniformly over the whole substrate surface. The layer 2A is applied to the substrate either in liquid phase, or advantageously in gel or gelled phase. When the layer 2A is applied to the substrate in liquid phase, the viscosity of the layer is generally between 50 mPa·s and 300 mPa·s. In a preferred embodiment, the viscosity of the layer is between 150 mPa·s and 250 mPa·s. The deposition techniques of the layer 2A in liquid phase can be the following: electro-polymerization, plasma polymerization, vapor phase polymerization, spraying, applicator deposition, dip deposition, stretch-flow deposition, liquid deposition using an engraved cylinder, basin deposition with layer limitation by air jet, doctor blade deposition, roller deposition, coating using a spiral screw, centrifugation deposition, deposition through slit, “waterfall” or “curtain” deposition. The last three techniques mentioned which enable several uniform layers to be deposited at the same time, and in a controlled way, are particularly interesting to use when the deposited liquid layer consists of a superimposition of several uniform layers. The choice of deposition technique will also depend on the layered thickness, the type of material to be deposited, the support (substrate), and on economic and quality constraints.

After the layer 2A has been applied in liquid phase to the substrate 1, it is gelled, i.e. it is put into the form of an easily deformable solid phase. This gel state can be achieved by a cooling process, or conversely by heating, or even by a chemical reaction between the components.

According to the third step of the process, the layer 2A is held in the gel state, and a prominent element 4 of an embossing device 3 penetrates through the whole thickness of the layer 2A. The prominent element 4 preferably penetrates into the layer 2A, in a direction perpendicular to the surface of the substrate 1, i.e., also in a direction perpendicular to the surface of the layer 2A. The prominent element 4 is geometrically defined, to be pushed through the layer 2A under the effect of a force generating, on the layer 2A, a pressure with a means (not shown) specific to the embossing device. The pressure determined on the layer 2A at the bottom part 12 of the prominent element 4 is generally between 1 mega-Pascal (MPa) and 1000 MPa. So that the layer becomes discontinuous, the pressure is suited to a minimal value that depends on the thickness of the material constituting the thin layer, its mechanical strength, the dimensions of the bottom part 12, and the application time of the pressure.

According to FIGS. 2 and 3, the prominent element 4 has bottom parts 12 to produce one or a plurality of prominent elements 11 in the layer 2A. In one embodiment, the embossing device 3 comprises a plurality of prominent elements 4 intended to form prominences in the thin layer, for example like the prominences shown in FIG. 5. Each prominence is, for example, square or rectangular shaped. But the prominences can also, for example, generate the shapes of segments forming figures, letters of an alphabet, even symbols or special graphics. They can also form straight, curved, or spiral lines, to provide the function of radio frequency antenna, or one-off elements to form transistors. The radio frequency antenna is used for example on labels that are intended to be radio-identified.

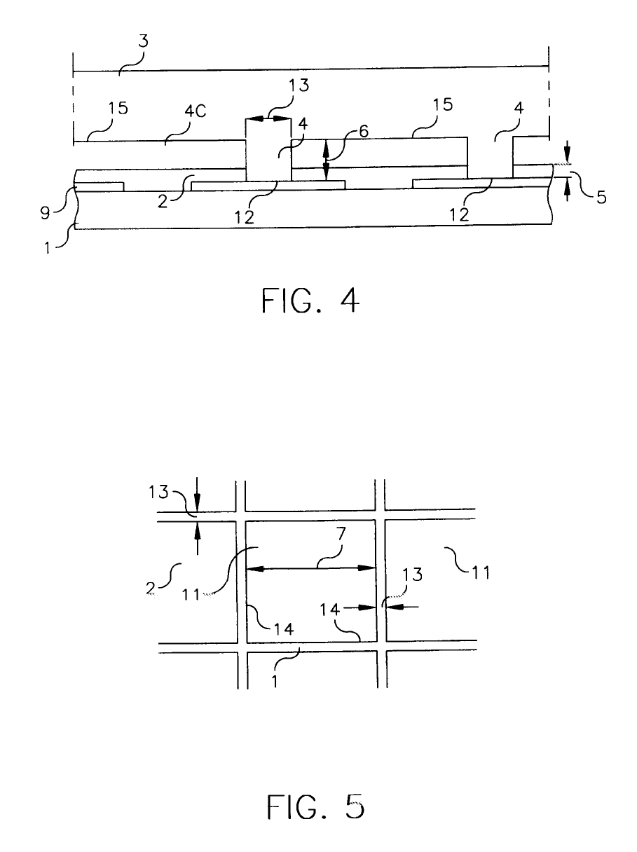

According to FIGS. 2 and 4, the embossing device 3 comprises a plurality of prominent elements 4, separated by hollow parts 4C. This plurality of prominent elements 4 separated by hollow parts 4C, can thus form, in the layer 2A, a prominence preferably having a square cross-section (see also FIG. 5). The prominence 11 is formed in the thin layer by the combination of bottom parts 12, and a central hollow part 4C of the embossing device 3. Each prominence 11 thus formed is isolated by another prominence.

In another embodiment, and according to FIGS. 2, 4, and 5, each hollow part 4C is surrounded by a grid of prominent elements 4 to form prominent elements 11 divided by narrower width grooves on the substrate 1. The prominent elements 11 have a width that corresponds to one dimension 7, from which twice the value of a space 13 existing between two consecutive prominent elements 11 is deducted. The dimension of the space 13 corresponds to one dimension of the bottom part 12 of the prominent element 4, and the dimension of the prominent element 11 shown by the edges 14 corresponds to one dimension of the hollow part 4C of the prominent element 4.

Other geometrical shapes of the discontinuous layer forming the prominences can be produced: for example, rectangular or hexagonal shapes (cavities). This simply means suiting the shapes and dimensions of the bottom part 12 of the prominent element 4 to the shapes of the prominent elements 11 envisaged. According to a particular use mode of the invention, prominent parts 11 can be defined that are electricity conductors, and linear or curved shapes to form advantageously the tracks of an electric circuit.

According to FIG. 3, an essential characteristic of the invention is that the same quantity of material 8 is embossed in each of the prominent parts 11 formed of the discontinuous layer 2. The quantity of embossed material 8 is evenly distributed all along the edges 14 of the prominent part 11. The process has the advantage, outside the zones that correspond to the quantity of material 8 embossed along the edges 14, of obtaining excellent evenness of the surface and of the coating thickness of each of the prominent parts 11 that form the discontinuous layer. This advantage is interesting, especially when dimensional accuracy is sought to produce a display screen or printed circuit.

According to the fourth step of the process, according to FIG. 2, and according to the first embodiment, the prominent element 4 penetrates into the whole thickness 5 of the layer 2A (i.e. the entire thickness), to form the discontinuous layer 2, and the prominent element 4 is removed from the discontinuous layer 2 which has been formed, the layer 2 staying in the gel state during the withdrawal of the prominent element 4. In this embodiment, the substrate 1 is previously put or fixed to a flat surface of a flat support (not shown in FIG. 2), and the embossing device 3 is arranged, for example, above this flat support.

In a fifth and last step, according to the invention process, the discontinuous layer 2 is transformed from the gel state to a solid rigid state. To perform this transformation from the gel state to the solid state, known technical processes can be used, for example like the evaporation of a solvent contained in the formed discontinuous layer, or the cross-linking of a polymer contained in the discontinuous layer under the effect of UV radiation (ultraviolet), or again by chemical reaction between the components contained in the layer.

In a variant of the first embodiment previously described (withdrawal of the prominent element before the solidification step), the prominent element is removed from the formed discontinuous layer 2 after the solidification step of the layer 2.

FIG. 4 represents a second embodiment of the invention. In this case, two discontinuous layers 9 and 2 are applied then formed successively on the substrate 1. All the steps of the process described above are performed successively, and respectively for each of the two layers. A first continuous layer is applied to the substrate 1, then the invention process is performed to form the first discontinuous layer 9 (undercoat). Then a second continuous layer is applied to the substrate 1, then the invention process is performed again to form the second discontinuous layer 2. In this embodiment, the substrate 1 is previously put or fixed onto a flat surface of a flat support (not shown in FIG. 2), and the embossing device 3 is arranged, for example, above this flat support.

Another characteristic of the invention is that, according to FIGS. 1 and 2, the height 6 of the prominent element 4 is higher than the thickness 5 of the thin layer deposited on the substrate 1. The thickness 5 corresponds to the thickness of the layer 2A just before penetration of the prominent element 4.

According to FIG. 2 or 4, it is necessary to plan enough difference between the height 6 of the prominent element 4 and the thickness 5 of the thin layer, so that the slight overthickness created by the embossed material 8 along the edges of the prominent part 11 does not produce contact of the formed discontinuous layer 2, with the neighboring part 15 of the embossing device 3, to which, for example, the prominent element 4 is fixed. In a particular embodiment, the thickness 5 is advantageously, for example, between 0.5 mm and 1.0 mm; this is for a thin layer that is practically 0.2 mm thick before penetration of the prominent element 4. The same thin layer not being more than 0.02 mm thick after drying, i.e. when it was transformed to the solid state by a process of solvent evaporation. All the steps of the invention process previously described can be performed iteratively for each of the layers of a substrate (not shown) to which at least three layers are applied.

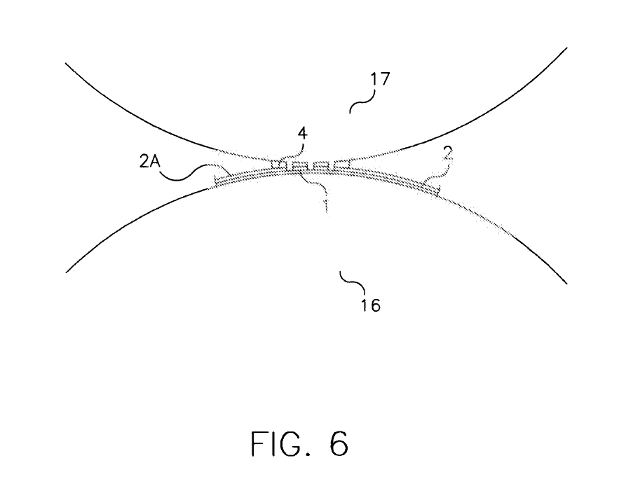

FIG. 6 schematically represents a third embodiment of the invention applied to the substrate 1 on which a thin material layer 2A is deposited. This third embodiment corresponds, no longer to a process implemented flat, like the embodiments described above, but to the running of the substrate between two revolving rollers, preferably cylindrical. A first roller 16 is placed for example opposite a second roller 17. The surface of the first roller 16 is used as a support on which the substrate 1 presses with a certain tension, per unit width of the support. This tension is typically between 100 N/m and 500 N/m. The first roller 16 turns for example in one direction making the substrate advance in relation to the second roller 17. The second roller 17 is provided with prominent elements 4 placed on its outer surface. To implement the invention method, the second roller 17 is intended to turn in the reverse direction to the first roller 16. The second roller 17 turns at the same instantaneous traveling speed (linear speed) as the first roller 16: speed measured at one point of the respective surfaces of said rollers. There is thus no relative slipping between the two rollers 16 and 17 during their rotation. The respective rotation axes of the two rollers 16 and 17 are parallel. The second roller 17 is set to a distance from the first roller 16, such that it is adjusted to enable, when the first roller 16 advances the substrate 1, the prominent element 4 of the second roller 17 to penetrate simultaneously with the advance through the whole thickness of the continuous thin layer 2A, to emboss the same quantity of material in the gel state forming the discontinuous thin layer 2 into each of the parts formed by the discontinuous layer 2. The pressure applied to the thin layer is preferably between 1 MPa and 1000 MPa. The inter-roller distance is adjusted so that the prominent element 4 crosses the whole thickness of the thin layer when a cross-section of the prominent element 4 is placed in the plane formed by the two parallel rotation axes of the rollers 16 and 17.

The ratio between the surface of the bottom part 12, or the sum of the surfaces of the bottom parts 12, of the prominent elements 4 of the embossing device and the surface of the continuous layer 2A applied to the substrate 1 constitutes the ratio of the sum of the surfaces of embossed material 8 to the total surface of the layer. For surface ratios less than 0.75, prominences 11 were created with the observation that the whole layer had been embossed evenly along the edges 14.

The invention also relates to a substrate 1 on which is deposited at least one thin material layer 2A having at least two prominent parts made in the whole thickness of the thin material layer, the prominences being obtained using the invention process described above according to the described embodiments. The substrate according to the invention has industrial applications in the production of electronic circuits, for example to fabricate radio frequency antennas, transistors with semiconductor polymers, electric tracks with conducting materials, and displays provided with segments, or grids of rows and columns. The substrate according to the invention can also be used to produce photosensitive digital sensors, or pixelized optical filters placed in front of digital screens.

The various operating parameters enabling implementation of the invention are described in the following examples.

### EXAMPLE 1

This example was based on the described embodiments that correspond to FIGS. 2 and 4. A layer 2A of a mixture of 20% limed ossein gelatin, dye and water having a viscosity of 220 mPa·s at 40° C. was coated onto or applied to a polyester support whose surface was previously gelatinized to facilitate adhesion. The polyester support was held in adhesion with a flat metal plate, at a temperature of 15° C. before, during and after the coating. The coating was performed using a doctor blade coating device. The thickness of the coated layer was practically 200 μm (micrometers). The gel was produced by lowering the layer's temperature. As this contained gelatin, it set. Sixty seconds after the coating operation, a series of 16 (sixteen) prominences 11 was formed by making the prominent elements 4 penetrate into the layer, perpendicular to the substrate 1, for a period of one second and with a pressure of 50 MPa, after which the embossing device 3 was removed from the layer. Following water elimination by drying, the layer had discontinuities and prominences. The discontinuous layers represented square-shaped segments, as shown in FIG. 5; the width 7 was 5.3 mm, and the size of the space 13 was 0.15 mm. The ratio between the sum of the surfaces of the bottom parts 12 of the prominent elements 4 of the embossing device and the surface of the continuous layer 2A was practically 0.06. Cross-section observation of the coated substrate showed that the whole of the layer was embossed along the edges 14 of the prominences 11.

### EXAMPLE 2

This example was based on the described embodiment that corresponds to FIG. 6. A layer 2A of a mixture of 20% limed ossein gelatin, dye and water having a viscosity of 220 mPa·s at 40° C. was coated (applied) onto a polyester support whose surface was previously gelatinized to facilitate adhesion. The cascade coating method was used. The polyester support, 100 micrometers thick, was maintained at a temperature of 5° C. after coating. The thickness of the layer 2A was 85 μm (micrometers). Sixty seconds after the coating operation, a prominence was formed with the layer by making the second roller 17 penetrate into the layer for a period less than 0.1 seconds. Following water elimination by drying, the layer had discontinuities and prominences. The discontinuous layers represented square-shaped segments, as shown in FIG. 5; the width 7 was 4.1 mm, and the size of the space 13 was 0.10 mm. The ratio between the sum of the surfaces of the bottom parts 12 of the prominent elements 4 of the embossing device and the surface of the continuous layer 2A was practically 0.05. Cross-section observation of the coated substrate showed that the whole of the layer 8 was embossed evenly along the edges 14 of the prominences 11.

### EXAMPLE 3

This example corresponded to the embodiment shown in FIG. 6. The layer 2A, the type of coating, the support and the operating conditions were the same as those of example 2. The discontinuous layers represented square-shaped segments similar to those in FIG. 5; the widths 7 were 3.0 mm, and the size of the space 13 was 1.0 mm. The ratio between the sum of the surfaces of the ends 12 of the prominent elements 4 of the embossing device and the surface of the continuous layer 2A was practically 0.75. According to a particular embodiment, the edges of the squares are aligned according to the axes of rotation of the cylinders. According to another particular embodiment, the edges of the squares form a 45 degree angle according to the axis of advance of the support. In both cases, cross-section observation of the coated substrate showed that the whole of the layer 8 was embossed evenly along the edges 14 of the prominences 11.

### EXAMPLE 4

This example was also based on the embodiment shown in FIG. 6. The layer 2A is identical to the one used in Example 2. The cascade coating method was used. The polyester support, 100 micrometers thick, was maintained at a temperature of 5° C. after coating. The thickness of the layer 2A was 21 μm (micrometers). Sixty seconds after the coating operation, a prominence was formed by making the second roller 17 penetrate into the layer for a period less than 0.1 seconds. Following water elimination by drying, the layer had discontinuities and prominences. The dry thickness of the layer at the center of the prominences 11 was 3 micrometers. The discontinuous layers represented figure eight-shaped segments. Cross-section observation of the coated substrate showed that the whole of the layer 8 was embossed evenly along the edges 14 of the prominences 11.

### EXAMPLE 5

This example was based on the described embodiment that corresponds to FIG. 6. The layer 2A, the coating method, the support and the operating conditions were the same as those of Example 4. The discontinuous layers represented spiral-shaped curved lines. Cross-section observation of the coated substrate showed that the whole of the layer 8 was embossed evenly along the edges 14 of the prominences 11.

The invention has been described in detail with particular reference to certain preferred embodiments thereof, but it will be understood that variations and modifications can be effected within the spirit and scope of the invention.

### PARTS LIST

1 substrate
2 discontinuous layer
2A layer
3 embossing device
4 prominent element
4C hollow part
5 thickness
6 height
7 dimension
8 embossed material
9 discontinuous layer
11 bottom part
13 space
14 edges
15 neighboring part
16 first roller
17 second roller

1. A process of forming a discontinuous layer with at least two parts on a substrate, comprising the following steps:
a) applying a continuous thin layer onto the substrate;
b) gelling the continuous thin layer applied onto the substrate;
c) penetrating, through a whole thickness of the gelled continuous thin layer, at least one prominent element of an embossing device, the prominent element penetrating into the continuous layer to push the same quantity of material forming the thin layer into each of the parts of the discontinuous layer formed by the penetration of the prominent element;
d) removing the prominent element from the discontinuous layer formed.

2. The process according to claim 1, wherein the continuous layer applied to the substrate consists of a superimposition of at least two separate continuous layers.

3. The process according to claim 1, comprising an additional step of solidification of the discontinuous layer formed, following removal of the prominent element.

4. The process according to claim 2, comprising an additional step of solidification of the discontinuous layer formed, following removal of the prominent element.

5. The process according to claim 3, wherein the prominent element is removed from the discontinuous layer following the step of solidification of the discontinuous layer formed.

6. The process according to claim 1, wherein the prominent element penetrates into the continuous layer, or is removed from the discontinuous layer formed, in a direction perpendicular to the surface of the substrate.

7. The process according to claim 5, wherein the prominent element penetrates into the continuous layer, or is removed from the discontinuous layer formed, in a direction perpendicular to the surface of the substrate.

8. The process according to claim 1, wherein the prominent element is placed on the outer surface of a first roll, the substrate to which the continuous layer is applied is placed in tension on the outer surface of a second roll whose rotation axis is parallel to the rotation axis of the first roll, to form the discontinuous layer when the rolls are rotated at the same linear speed.

9. The process according to claim 5, wherein the prominent element is placed on the outer surface of a first roll, the substrate to which the continuous layer is applied is placed in tension on the outer surface of a second roll whose rotation axis is parallel to the rotation axis of the first roll, to form the discontinuous layer when the rolls are rotated at the same linear speed.

10. The process according to claim 8, wherein the tension per unit width of the support applied to the substrate on the outer surface of the second roll is between 100 N/m and 500 N/m.

11. The process according to claim 1, wherein at least two continuous thin material layers are deposited on the substrate to form at least two discontinuous layers by applying successively, to each of said layers.

12. The process according to claim 10, wherein at least two continuous thin material layers are deposited on the substrate to form at least two discontinuous layers by applying successively, to each of said layers.

13. The process according to claim 1, wherein the height of the prominent element is higher than the height of the layer deposited on the substrate.

14. The process according to claim 11, wherein the height of the prominent element is higher than the height of the layer deposited on the substrate.

15. The process according to claim 1, wherein the ratio between the surface of the end of at least one prominent element of the embossing device and the surface of the continue layer is less than 0.75.

16. The process according to claim 13, wherein the ratio between the surface of the end of at least one prominent element of the embossing device and the surface of the continue layer is less than 0.75.

17. The process according to claim 1, wherein the prominent element penetrates into the continuous layer under the effect of a pressure applied to said layer of preferably between 1 MPa and 1000 MPa, so as to form the discontinuous layer.

18. The process according to claim 1, wherein the prominent element is comprised of a metal material, for example like steel.

19. The process according to claim 1, wherein the continuous thin layer is applied in liquid phase onto the substrate, with a viscosity of said layer between 50 mPa·s and 300 mPa·s.

20. The process according to claim 19, wherein the viscosity of the continuous thin layer is preferably between 150 mPa·s and 250 mPa·s.

21. The process according to claim 1, wherein the continuous thin layer is applied in gelled phase onto the substrate.

22. A composite substrate on which is deposited at least one thin material layer having at least two prominent parts made in the whole thickness of the thin material layer, the prominence being obtained using the process according to claim 1.

23. A composite substrate according to claim 22 comprised of a rigid material, constituted by metal, glass, or silicon.

24. A composite substrate according to claim 22, comprised of a flexible material, constituted by polyester, paper, or cellulose acetate.

25. A composite substrate according to claim 24, wherein the thin material layer is electricity conducting.

26. A composite substrate according to claim 22, wherein the prominent part is square or rectangular shaped according to a cross-section in a plane parallel to the substrate.

27. A composite substrate as in claim 25 is an electronic display screen.

28. A composite substrate as in claim 25 is a radio frequency antenna.

29. A composite substrate as in claim 25 is support for electrical circuit having electronic functions.
